(19) United States
(12) Patent Application Publication
(10) Pub. No.: US 2024/0139857 A1
(43) Pub. Date: May 2, 2024

(54) ULTRASONIC ASSISTED TRIMMING OF BATTERY FOIL

(71) Applicant: Rivian IP Holdings, LLC, Plymouth, MI (US)

(72) Inventors: Prathamesh Bilgunde, Sunnyvale, CA (US); Susheel Teja Gogineni, Sunnyvale, CA (US)

(21) Appl. No.: 18/050,238

(22) Filed: Oct. 27, 2022

(51) Int. Cl. B23K 20/10; B23K 20/26; H01M 4/04; H01M 50/536

(52) U.S. Cl. CPC B23K 20/10; B23K 20/26; H01M 4/04; H01M 50/536; B23K 2101/36

(57) ABSTRACT

An apparatus that can include a horn having a welding interface is provided. The horn can oscillate the welding interface at a first resonance frequency to weld a foil. The apparatus can include a trimmer coupled with the horn. The horn can oscillate the trimmer at a second resonance frequency to trim the foil.

### INTRODUCTION

Battery cells can include electrode material. The electrode material can be used to form the battery cell.

### SUMMARY

An apparatus for welding and trimming foils that make up stacked electrode material of a battery cell is described herein. The apparatus can include a horn having a welding interface and a trimmer coupled with the horn. The horn can oscillate the welding interface at a first resonance frequency to weld the foil. The horn can also oscillate the trimmer at a second resonance frequency to trim the foil. The horn can oscillate the welding interface to weld the foil and to oscillate the trimmer to trim the foil simultaneously. For example, the apparatus can improve efficiencies in the welding and trimming assembly process of building stacked electrode material (e.g., reduce cycle times up to 50%). The horn can also oscillate the welding interface to weld the foil and to oscillate the trimmer to trim the foil sequentially. For example, the apparatus can oscillate the trimmer to trim the foil to reduce wear and tear on cutting interfaces used in the trimming process (e.g., reduce force used to trim the foil) to improve component lifetimes, and reduce costs associated with fabricating stacked electrode material.

At least one aspect is directed to an apparatus. The apparatus can include a horn having a welding interface, the horn configured to oscillate the welding interface at a first resonance frequency to weld a foil. The apparatus can include a trimmer coupled with the horn, the horn configured to oscillate the trimmer at a second resonance frequency to trim the foil.

At least one aspect is directed to a method. The method can include providing a horn having a welding interface, the horn configured to oscillate the welding interface at a first resonance frequency to weld a foil. The method can also include providing a trimmer coupled with the horn, the horn configured to oscillate the trimmer at a second resonance frequency to trim the foil.

At least one aspect is directed to a method. The method can include receiving a foil. The method can include welding the foil, via a horn having a welding interface, the welding including oscillating the welding interface at a first resonance frequency to weld the foil. The method can also include trimming the foil, via a trimmer coupled with the horn, the trimming including oscillating the trimmer at a second resonance frequency to trim the foil.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with implementations.

FIG. 2A depicts a battery pack, in accordance with implementations.

FIG. 2B depicts a battery module, in accordance with implementations.

FIG. 2C depicts a cross-sectional view of a battery cell, in accordance with implementations.

FIG. 2D depicts a cross-sectional view of a battery cell, in accordance with implementations.

FIG. 2E depicts a cross-sectional view of a battery cell, in accordance with implementations.

FIG. 3 depicts an example side view of an apparatus for welding and trimming a foil of a stack of electrode material, in accordance with implementations.

FIG. 4 depicts an example side view of the apparatus of FIG. 3, in accordance with implementations.

FIG. 5 depicts an example side view of the apparatus of FIG. 3, in accordance with implementations.

FIG. 6 depicts an example side view of the apparatus of FIG. 3, in accordance with implementations.

FIG. 7 depicts an example side view of the apparatus of FIG. 3, in accordance with implementations.

FIG. 8 depicts an example side view of the apparatus of FIG. 3, in accordance with implementations.

FIG. 9 depicts an example illustration of a method, in accordance with implementations.

FIG. 10 depicts an example illustration of a method, in accordance with implementations.

FIG. 11 depicts an example illustration of a method, in accordance with implementations.

### DETAILED DESCRIPTION

Following below are more detailed descriptions of various concepts related to, and implementations of, apparatuses, systems, and methods of welding and trimming a battery foil. The various concepts introduced above and discussed in greater detail below may be implemented in any of numerous ways.

The present disclosure is generally directed to an ultrasonic welding and trimming apparatus that welds and trims foils that make up stacked electrode material (e.g., an anode layer, a cathode layer, a layer of other electrode material) of a battery cell. The process of forming an electrode stack can include first stacking the electrode material including the coated foils (e.g., stacking multiple layers of anode layer, an electrolyte or separator layer, a cathode layer), and then welding (e.g., via ultrasonic welding) the foils to form a tab. After the foils are welded and the tabs are formed, the tab may be moved to a trimming machine, where the foils are cut or trimmed (e.g., via a die-cut knife or blade). To capitalize on the advantages provided by ultrasonic-assisted cutting, such as reduced cutting forces, improved trimming margins, and higher product yield, the present application provides an apparatus that includes a horn having an oscillating welding interface and an oscillating trimmer that can simultaneously weld and trim the foils that make up stacked electrode material. This can improve efficiencies in the welding and trimming assembly process of building stacked electrode material (e.g., reduce cycle times up to 50%), reduce wear and tear on cutting interfaces used in the trimming process to improve component lifetimes, and reduce costs associated with fabricating stacked electrode material. Further, the foil can be welded or trimmed to build at least one electrode stack that can be used to build a battery cell (e.g., an elongated battery cell), for example to be used to build a cell to pack (“CTP”) battery pack.

The proposed solution can include a horn having a welding interface and a trimmer coupled with the horn. The horn can oscillate the welding interface at a first resonance frequency to weld a foil. The horn can oscillate the trimmer at a second resonance frequency to trim the foil. The horn can oscillate the welding interface to weld the foil and to oscillate the trimmer to trim the foil simultaneously, for example to improve efficiencies in the welding and trimmer assembly process. For example, the horn can oscillate the welding interface during a first acoustic burst to weld the foil, and the horn can oscillate the trimmer during a second acoustic burst to trim the foil, where the first acoustic burst at least partially overlaps in time with the second acoustic burst. The horn can oscillate the welding interface to weld the foil and oscillate the trimmer to trim the foil sequentially, for example to reduce costs associated with fabricating the stacked electrode material. For example, the horn can oscillate the welding interface during a first acoustic burst to weld the foil, and the horn can oscillate the trimmer during a second acoustic burst to trim the foil, where the first acoustic burst and the second acoustic burst proceed sequentially in time.

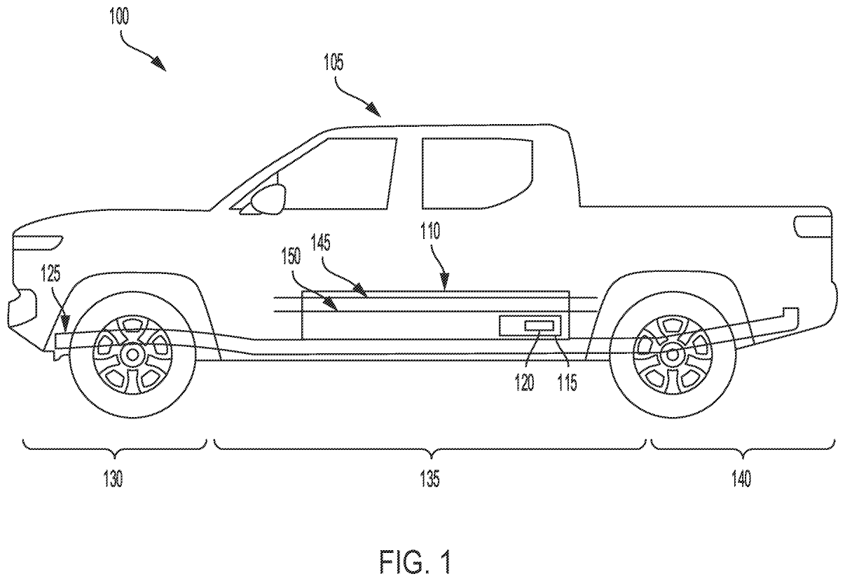

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple a battery, the battery modules 115, or the battery cells 120 with other electrical components of the electric vehicle 105 to provide electrical power to various systems or components of the electric vehicle 105.

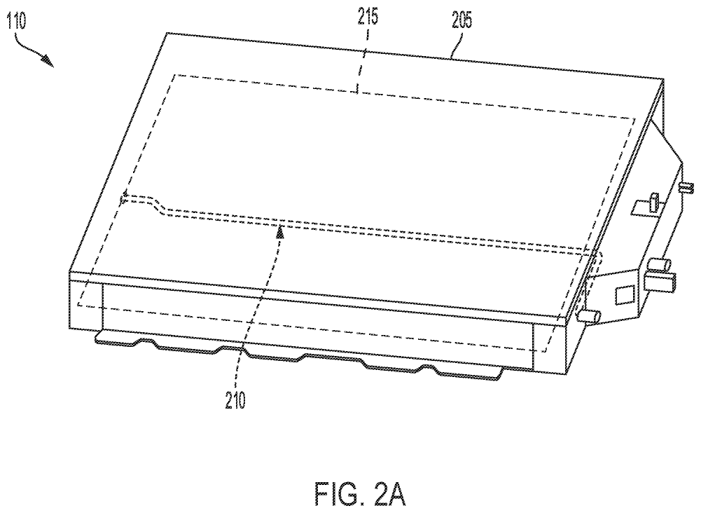

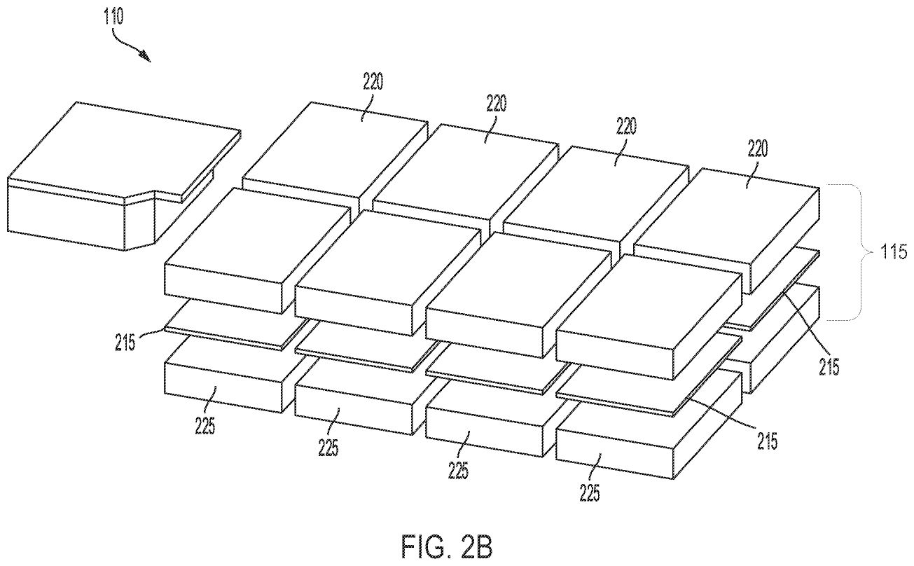

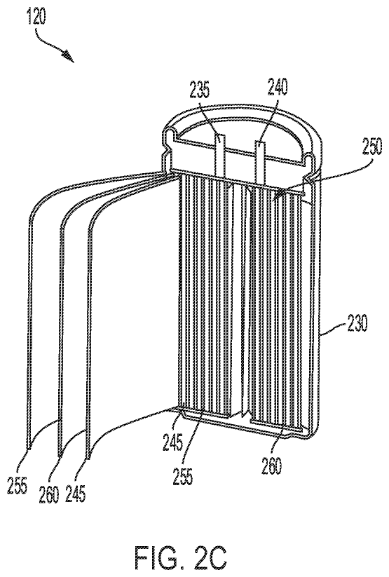

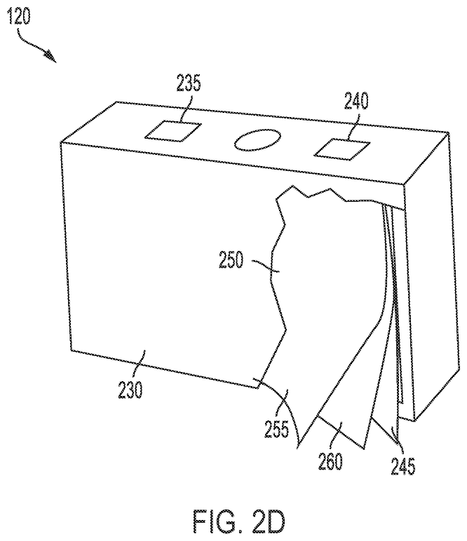

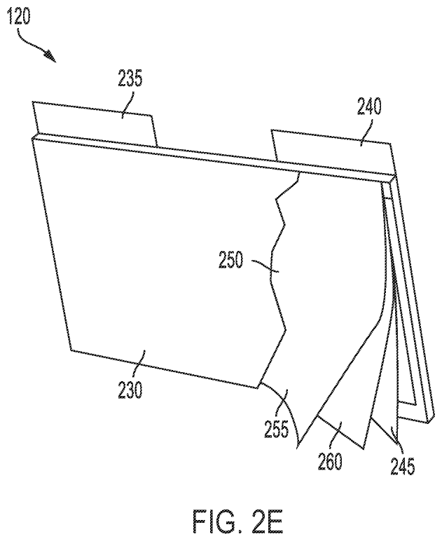

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 or battery cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 or battery cells 120. The battery modules 115 can be square, rectangular, circular, triangular, symmetrical, or asymmetrical. In some examples, battery modules 115 can be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery submodules 220 and 225. The battery cells 120 can be disposed in the battery pack 110 in a cell-to-pack configuration without submodules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. A separator can be wetted with a liquid electrolyte. The liquid electrolyte can be diffused into the anode layer 245. The liquid electrolyte can be diffused into the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

The battery cell 120 can include at least one electrode layer that forms a portion of an electrode stack of a battery cell 120. For example, as described herein, the electrode layers can include or can be an anode layer 245 or a cathode layer 255. The electrode stack can include a plurality of electrodes having one or more separators between the electrodes. For example, an electrode stack can include a first electrode (e.g., an anode layer 245), a separator layer, and a second electrode (e.g., a cathode layer 255) coupled together to form an electrode stack, as described in greater detail herein. The electrode stack can include any number of electrodes.

Each electrode can include an active or coated region and an uncoated (e.g., inactive) region. The coated region can include an active material that is coated on a thin metallic surface (e.g., a metallic foil). For example, the coated region can include coating a foil formed of aluminum, copper, nickel, or another metallic material with an active material such as metal oxide, graphite, carbon black, carbon nanotubes, Super P carbon black material, Ketjen Black, Acetylene Black, SWCNT, MWCNT, graphite, carbon nanofiber, graphene, high-nickel content (>80% Ni) lithium transition metal oxide, a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”), or another active material.

The uncoated region can be in electrical contact or a physical contact with the coated region. The uncoated region can provide, establish, or create an electrical contact or continuity between the coated region and a current collector. An electrode can be or can include a notched (e.g., cut away, carved, etc.) foil or a foil without any notches. For example, the uncoated region can be notched to form a tab of the electrode, in which case, the uncoated region can have a smaller dimension width than the coated region and can also be referred to as an electrode tab. In some examples, the uncoated region may not be notched in which the coated region and uncoated regions can have the same dimension. A current collector can be formed of various types of aluminum, copper, nickel, or other metallic material.

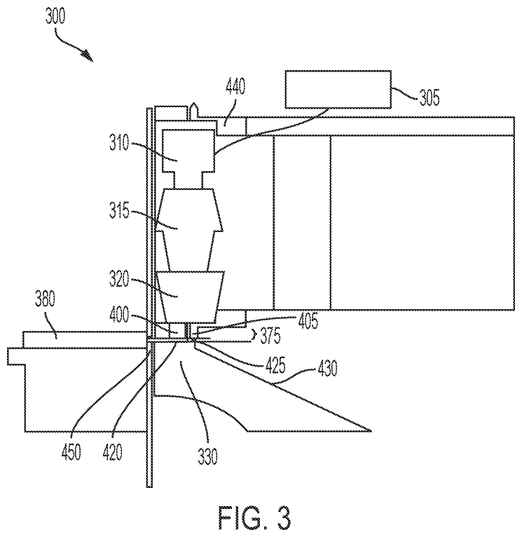

FIG. 3 depicts an example side view of a system for welding and trimming at least one foil that makes up stacked electrode material of a battery cell. For example, the system can weld or trim at least one foil that makes up stacked electrode material (e.g., an electrode, the anode layer 245, the cathode layer 255, or another other electrode material). An electrode stack can include one or more layers of material, for example one or more anode layers, electrolyte layers, or cathode layers (e.g., stacked layers). The system can weld or trim a region of the at least one foil, for example an uncoated region. The system can also weld or trim at least one foil that makes up other stacked electrode material (e.g., the electrolyte layer 260), or at another region of the at least one foil that includes another characteristic (e.g., a coated region).

As described herein, the system can be an apparatus 300. The apparatus 300 can include at least one generator 305 (e.g., power supply) at least one transducer 310 (e.g., converter), at least one booster 315, and at least one horn 320 (e.g., sonotrode). The generator 305 can couple with the transducer 310, and the generator 305 can generate a current. For example, the generator 305 can convert an electrical power to a high frequency current. The transducer 310 can receive the high frequency current from the generator 305, and the transducer 310 can convert electrical energy (e.g., the high frequency current) to mechanical vibrations. For example, the transducer 310 can be a piezoelectric transducer, or another suitable transducer (e.g., current, pressure, electromechanical, or another type of transducer), and can convert the high frequency current to mechanical vibrations. The transducer 310 can also couple the booster 315, and the booster 315 can modify (e.g., amplify or attenuate) the amplitude of mechanical vibrations. For example, the booster 315 can receive the mechanical vibrations from the transducer 310, and the booster 315 can increase or decrease an output amplitude of the mechanical vibrations by a ratio (e.g., 1:0.25, 1:0.5, 1:0.75, 1:1.5, 1:2, 1:3, 1:5, or another ratio). The booster 315 can couple with the horn 320, and the horn 320 can also modify (e.g., amplify or attenuate) the amplitude of mechanical vibrations. For example, the horn 320 can receive the mechanical vibrations from the booster 315, and can increase or decrease the output amplitude of the mechanical vibrations by a ratio (e.g., 1:0.25, 1:0.5, 1:0.75, 1:1.5, 1:2, 1:3, 1:5, or another ratio).

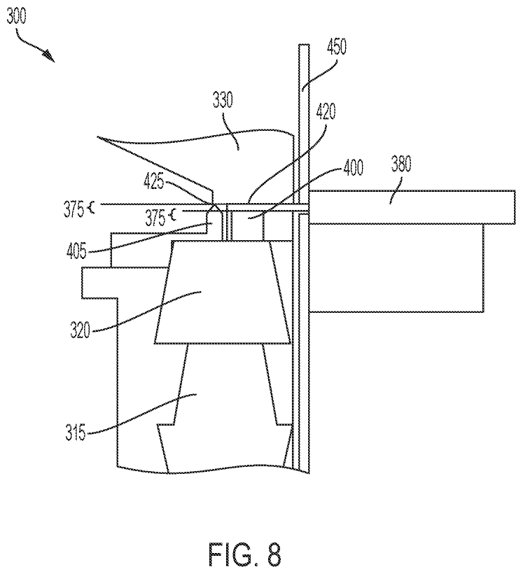

The apparatus 300 can also include at least one anvil 330. The anvil 330 can be positioned opposite the horn 320 and can receive at least one foil 375, for example to position, orient, or retain the foil 375 during welding or trimming. For example, the anvil 330 can be positioned below the horn 320, and can receive the foil 375 at a top surface of the anvil 330 (depicted in at least FIGS. 3-7). The anvil 330 can also be positioned above the horn 320, for example to receive the foil 375 at a bottom surface of the anvil 330 (depicted in at least FIG. 8), or at another suitable position relative to the horn 320 (e.g., at a side, at a front, at a rear). The anvil 330 can receive the foil 375, for example to position, orient, or retain the foil during welding or trimming of the foil 375 to build stacked electrode material (e.g., stacked electrode material).

The foil 375 can be welded or trimmed to build at least one electrode stack 380. For example, the foil 375 can be welded or trimmed to build an electrode (e.g., the anode layer 245, the cathode layer 255, or another electrode material). The foil 375 can be welded or trimmed at a region of the foil 375, for example an uncoated region of the foil 375. The foil 375 can also be welded or trimmed as a component of the electrode stack 380 (e.g., the electrolyte layer 260), or another component of the battery cell 120 or battery pack 110. The foil 375 can also be welded or trimmed at another region of the foil 375, for example a coated region of the foil 375.

FIGS. 1-6, among others, depict example side views of the apparatus 300, in accordance with some implementations. The apparatus 300 can include at least one horn 320 (depicted in at least FIGS. 2-8). For example, the horn 320 can couple the booster 315, and can increase or decrease the amplitude of mechanical vibrations received from the booster 315 by a ratio (e.g., 1:0.25, 1:0.5, 1:0.75, 1:1.5, 1:2, 1:3, 1:5, or another ratio). A first portion of the horn 320 can oscillate at a first resonance frequency along a first axis. For example, a first portion of the horn 320 can oscillate at a first resonance frequency of about (e.g., within 10%) 40 kHz along a first axis that is aligned with a welding surface of the anvil 330. A second portion of the horn 320 can oscillate at a second resonance frequency along a second axis. For example, a second portion of the horn 320 can oscillate at a second resonance frequency of about (e.g., within 10%) 40 kHz along a second axis that is aligned with a trimming surface of the anvil 330. The horn 320 can also oscillate during at least one acoustic burst. For example, the horn 320 can oscillate the first portion of the horn 320 during a first acoustic burst, and the second portion of the horn 320 during a second acoustic burst. The first acoustic burst can at least partially overlap in time with the second acoustic burst, or the first acoustic burst and the second acoustic burst can proceed sequentially in time. The horn 320 can oscillate at another frequency (e.g., 10 kHz, 15 kHz, 20 kHz, 30 kHz, 50 kHz, 60 kHz, 80 kHz, or another frequency) or a range of frequencies (e.g., 10-20 kHz, 20-30 kHz, 20-40 kHz, 40-60 kHz, 40-80 kHz, or another frequency range). The horn 320 can also oscillate along another axis (e.g., an axis that is perpendicular to a welding surface or trimming surface of the anvil 330, an axis that is misaligned with a welding surface or trimming surface of the anvil 330, or another axis) or during another acoustic burst (e.g., a third acoustic burst, a fourth acoustic burst, or another acoustic burst).

The horn 320 can include at least one welding interface 400 (depicted in at least FIGS. 3-4, 6, and 8). The welding interface 400 can interface (e.g., contact, engage, or otherwise interact) with the foil 375. The welding interface 400 can oscillate at a first resonance frequency to weld the foil 375. For example, the welding interface 400 can oscillate at a first resonance frequency of about (e.g., within 10%) 40 kHz to weld the foil 375. The welding interface 400 can oscillate at another resonance frequency (e.g., 10 kHz, 15 kHz, 20 kHz, 30 kHz, 50 kHz, 60 kHz, 80 kHz, or another frequency) or a range of frequencies (e.g., 10-20 kHz, 20-30 kHz, 20-40 kHz, 40-60 kHz, 40-80 kHz, or another frequency range) to weld the foil 375. The welding interface 400 can couple with the horn 320, for example via a mechanical connection (e.g., threading, hook/loop, pin, or other suitable coupling connection). For example, the welding interface 400 can removably couple the horn 320 to permit replacement of the welding interface 400. The welding interface 400 can be formed of steel, titanium, tungsten carbide (e.g., 6% cobalt, 8% cobalt, 10% cobalt), or another suitable metal or other material.

The welding interface 400 can oscillate during at least one first acoustic burst to weld the foil 375. The first acoustic burst can at least partially overlap in time with another acoustic burst (e.g., a second acoustic burst). The first acoustic burst can proceed sequentially in time with another acoustic burst (e.g., a second acoustic burst). The first acoustic burst can proceed at another time (e.g., partially overlaps, sequentially, or at another time) or with another acoustic burst (e.g., a third acoustic burst, a fourth acoustic burst, or another acoustic burst).

The welding interface 400 can oscillate along at least a first axis to weld the foil 375. For example, the welding interface 400 can oscillate along a first axis that is aligned with (e.g., parallel to) a welding surface of the anvil 330. The welding interface 400 can also oscillate along a first axis that is misaligned with a welding surface of the anvil 330 (e.g., perpendicular to, angled relative to, or otherwise oriented). The welding interface 400 can oscillate along a first axis that is perpendicular to a vertical axis of the horn 320, or the first axis can be otherwise oriented relative to a vertical axis of the horn 320 (e.g., angled with, misaligned from, or otherwise oriented).

The welding interface 400 can couple with an end portion of the horn 320 (as depicted in at least FIGS. 3-4, 6, and 8). For example, the welding interface 400 can couple with a bottom portion of the horn 320 (as depicted in at least FIGS. 3-4 and 6). The welding interface 400 can interface with (e.g., contact, engage, or otherwise interface) a top surface of the foil 375 to weld the foil 375. The welding interface 400 can couple with a top portion of the horn 320 (as depicted in at least FIG. 8). The welding interface 400 can interface with (e.g., contact, engage, or otherwise interface) a bottom surface of the foil 375 to weld the foil 375. The welding interface 400 can de-couple (e.g., detach, disengage, separate, unfasten) from the horn 320, for example the welding interface 400 can be removable or detachable.

The apparatus 300 can also include at least one trimmer 405 (as depicted in at least FIGS. 3-8). The trimmer 405 can include a blade (e.g., die-cut blade, punch cut blade, knife blade, toothed blade, or another suitable trimming interface). The trimmer 405 can interface (e.g., contact, engage, or otherwise interact) with the foil 375 to trim the foil 375. For example, the trimmer 405 can oscillate at a second resonance frequency to trim the foil 375. The trimmer 405 can oscillate at a second resonance frequency of about (e.g., within 10%) 40 kHz to trim the foil 375. The trimmer 405 can oscillate at another resonance frequency (e.g., 10 kHz, 15 kHz, 20 kHz, 30 kHz, 50 kHz, 60 kHz, 80 kHz, or another frequency) or a range of frequencies (e.g., 10-20 kHz, 20-30 kHz, 20-40 kHz, 40-60 kHz, 40-80 kHz, or another frequency range) to trim the foil 375. The trimmer 405 can be formed of steel (e.g., tool steel, high speed steel, or another suitable steel), titanium, or another suitable metal or material to trim the foil 375.

The trimmer 405 can oscillate during at least one second acoustic burst to trim the foil 375. The second acoustic burst can at least partially overlap in time with another acoustic burst. For example, the second acoustic burst (e.g., to trim the foil 375) can at least partially overlap with the first acoustic burst (e.g., to weld the foil 375). The second acoustic burst can proceed sequentially in time with another acoustic burst. For example, the second acoustic burst (e.g., to trim the foil 375) can proceed sequentially in time with the first acoustic burst (e.g., to weld the foil 375). The second acoustic burst can proceed at another time (e.g., partially overlaps, sequentially, or at another time) with another acoustic burst (e.g. a third acoustic burst, a fourth acoustic burst, or another acoustic burst).

The trimmer 405 can oscillate along at least a second axis to trim the foil 375. For example, the trimmer 405 can oscillate along a second axis that is aligned with (e.g., parallel to) a trimming surface of the anvil 330. The second axis (e.g., to trim the foil 375) can be oriented relative to another axis (e.g., an axis to weld the foil 375). For example, the second axis (e.g., to trim the foil 375) can be aligned with (e.g., parallel to) the first axis (e.g., to weld the foil 375). The second axis can be misaligned with (e.g., angled relative to, perpendicular to, or otherwise oriented) the first axis. The trimmer 405 can oscillate along a second axis that is misaligned with a trimming surface of the anvil 330 (e.g., perpendicular to, angled relative to, or otherwise oriented). The trimmer 405 can oscillate along a second axis that is perpendicular to a vertical axis of the horn 320, or the second axis can be otherwise oriented relative to a vertical axis of the horn 320 (e.g., angled with, misaligned from, or otherwise oriented).

The trimmer 405 can couple with an end portion of the horn 320 (as depicted in at least FIGS. 3-8). For example, the trimmer 405 can couple with a bottom portion of the horn 320 (as depicted in at least FIGS. 3-7). The trimmer 405 can interface with (e.g., contact, engage, or otherwise interface) a top surface of the foil 375 to trim the foil 375. The trimmer 405 can couple with a top portion of the horn 320 (as depicted in at least FIG. 8). The trimmer 405 can interface with (e.g., contact, engage, or otherwise interface) a bottom surface of the foil 375 to trim the foil 375. The trimmer 405 can de-couple (e.g., detach, disengage, separate, unfasten) from horn 320, for example the trimmer 405 can be removable or detachable.

The horn 320 can oscillate the welding interface 400 at a first resonance frequency to weld the foil 375, or the horn 320 can oscillate the trimmer 405 at a second resonance frequency to trim the foil 375. The first resonance frequency and the second resonance frequency can be the same frequencies. For example, the horn 320 can oscillate the welding interface 400 at a first resonance frequency of about (e.g., within 10%) 40 kHz and the trimmer 405 at a second resonance frequency of about (e.g., within 10%) of 40 kHz. The first resonance frequency and the second resonance frequency can be different frequencies (e.g., 10 kHz, 15 kHz, 20 kHz, 30 kHz, 50 kHz, 60 kHz, 80 kHz, or another frequency) or a range of frequencies (e.g., 10-20 kHz, 20-30 kHz, 20-40 kHz, 40-60 kHz, 40-80 kHz, or another frequency range) to weld or trim the foil 375.

The horn 320 can oscillate the welding interface 400 to weld the foil 375, or the horn 320 can oscillate the trimmer 405 to trim the foil 375, and the foil 375 can be a first foil of a plurality of foils. For example, the foil 375 can be one of a plurality of foils comprising at least 90 layers of foil. The plurality of foils can include another number of foils (e.g., at least 60 foils, at least 75 foils, at least 120 foils, or another suitable number of foils). As such, the horn 320 can oscillate the welding interface 400 to weld the foil 375, where the foil 375 is one of a plurality of foils comprising at least 90 layers of foil. Further, the horn 320 can oscillate the trimmer 405 to trim the foil 375, where the foil 375 is one of a plurality of foils comprising at least 90 layers of foil.

The horn 320 can also oscillate the welding interface 400 to weld the foil 375 and oscillate the trimmer 405 to trim the foil 375 simultaneously. For example, the horn 320 can oscillate the welding interface 400 during a first acoustic burst to weld the foil 375, and the horn 320 can oscillate the trimmer 405 during a second acoustic burst to trim the foil 375, where the first acoustic burst at least partially overlaps in time with the second acoustic burst. The horn 320 can also oscillate the welding interface 400 to weld the foil 375 and oscillate the trimmer 405 to trim the foil 375 sequentially. For example, the horn 320 can oscillate the welding interface 400 during a first acoustic burst to weld the foil 375, and the horn 320 can oscillate the trimmer 405 during a second acoustic burst to trim the foil 375, where the first acoustic burst and the second acoustic burst proceed sequentially in time.

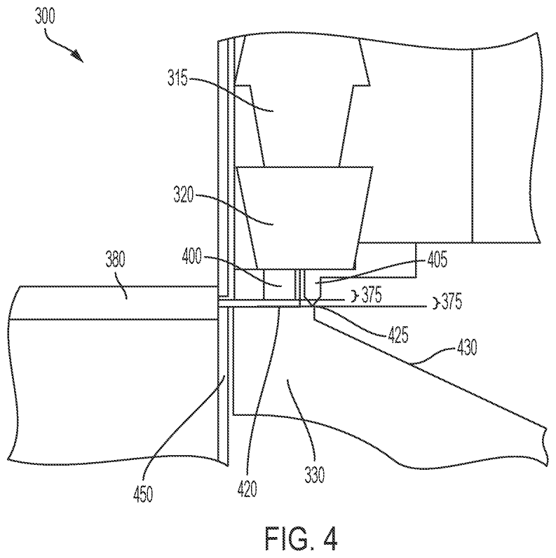

The apparatus 300 can include at least one anvil 330 (as depicted in at least FIGS. 3-8). The anvil 330 can include at least one welding surface 420 (as depicted in at least FIGS. 3-4, 6, and 8). The welding surface 420 can be a planar surface to interface with (e.g., contact, engage, or otherwise interact) the foil 375, for example to facilitate welding the foil 375. The welding surface 420 can be positioned opposite the welding interface 400. For example, the welding surface 420 can be positioned below the welding interface 400 (as depicted in at least FIGS. 3-4), or the welding surface 420 can be positioned above the welding interface 400 (as depicted in at least FIG. 8). The welding surface 420 can receive the foil 375, for example to position or orient the foil 375 between the anvil 330 and the welding interface 400 to weld the foil 375 (as depicted in at least FIGS. 3-4, 6, and 8).

The anvil 330 can also include at least one trimming surface 425 (as depicted in at least FIGS. 3-8). The trimming surface 425 can be a planar surface to interface with (e.g., contact, engage, or otherwise interact) the foil 375, for example to facilitate trimming the foil 375. The trimming surface 425 can be positioned opposite the trimmer 405. For example, the trimming surface 425 can be positioned below the trimmer 405 (as depicted in at least FIGS. 3-7), or the trimming surface 425 can be positioned above the trimmer 405 (as depicted in at least FIG. 8). The trimming surface 425 can receive the foil 375, for example to position or orient the foil 375 between the anvil 330 and the trimmer 405 to trim the foil 375 (as depicted in at least FIGS. 3-8).

The anvil 330 can also include at least one sloped surface 430 (as depicted in at least FIGS. 3-7). The sloped surface 430 can be a planar surface to interface with (e.g., contact, engage, or otherwise interact) a portion of the foil 375, for example to facilitate removal (e.g., discarding, disposal) of a portion of the foil 375. The sloped surface 430 can be positioned opposite the trimmer 405 (e.g., adjacent to the trimming surface 425). For example, the sloped surface 430 can be positioned adjacent to the trimming surface 425 below the trimmer 405 (as depicted in FIGS. 3-7). The sloped surface 430 can receive a portion of the foil 375, for example a portion of the foil 375 separated from the foil 375 after the trimmer 405 trims the foil 375.

The apparatus 300 can include at least one balancer 440 (as depicted in at least FIGS. 3 and 6-7). The balancer 440 can include a mass (e.g., a weight) and can oscillate at a third frequency, for example to maintain a motion of the horn 320 during welding or trimming. For example, the balancer 440 can couple with a housing of the apparatus 300, and can be positioned a distance from the horn 320 (as depicted in at least FIGS. 1 and 4-5). The balancer 440 can oscillate at a third frequency (e.g., 10 Hz, 15 Hz, 20 Hz, 10 kHz, 20 kHz, 40 kHz, 60 kHz, or another frequency), for example in response to oscillation of the horn 320. The balancer 440 can oscillate at a third frequency to maintain a longitudinal motion (e.g., horizontal, lateral) of the horn 320, for example during oscillation of the welding interface 400 during welding or during oscillation of the trimmer 405 during trimming. The balancer 440 can be a trimmer (e.g., the trimmer 405). For example, the balancer 440 can be a trimmer (e.g., the trimmer 405) positioned at a top portion of the apparatus 300, and can be used to replace the trimmer 405 (e.g., after a lifecycle or use of the trimmer 405).

The apparatus 300 can include at least one guide 450 (as depicted in at least FIGS. 3-8). The guide 450 can be positioned to orient the foil 375, for example to position the foil 375 at the welding interface 400 or at the trimmer 405. For example, the guide 450 can be positioned to orient the foil 375 a first distance from the guide 450 at the welding interface 400, or a second distance from the guide 450 at the trimmer 405. The first distance (e.g., a distance between the guide 450 and the welding interface 400) can be less than the second distance (e.g., a distance between the guide 450 and the trimmer 405). The guide 450 can couple with the anvil 330. For example, the guide 450 can couple with the anvil 330 and extend vertically along a vertical axis of the apparatus 300 (e.g., a lateral side). The guide 450 can couple with the anvil 330, for example to position or orient the foil 375 via a bottom surface of the foil 375. The guide 450 can also couple with a housing of the apparatus 300, for example to position or orient the foil 375 via a top surface of the foil 375. The guide 450 can couple with another component of the apparatus 300 (e.g., a housing, a support surface, or another component), or can extend in another direction (e.g., a horizontal, angled relative to the welding surface 420 or the trimming surface 425, or in another suitable orientation).

The apparatus 300 can have an inverted configuration (as depicted in at least FIG. 8). For example, the apparatus 300 can have the horn 320 having the welding interface 400 or the trimmer 405 coupled with a top portion of the horn 320. The anvil 330 can be positioned opposite the horn 320, for example above the horn 320 (e.g., the welding interface 400, the trimmer 405). The anvil 330 can receive the foil 375, for example to facilitate welding or trimming a bottom surface of the foil 375. In some implementations, the anvil 330 need not include the sloped surface 430 (as depicted in at least FIG. 8). The apparatus 300 need not include the balancer 440. For example, the apparatus 300 (e.g., the transducer 310, the booster 315, the horn 320) can couple with a support structure (e.g., ground, base surface), and the positioning or orientation of the apparatus 300 can maintain a longitudinal motion (e.g., horizontal, lateral) of the horn 320 during oscillation of the welding interface 400 during welding or during oscillation of the trimmer 405 during trimming.

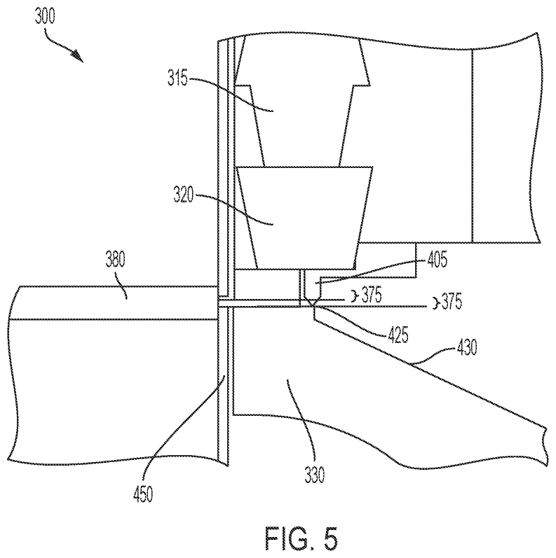

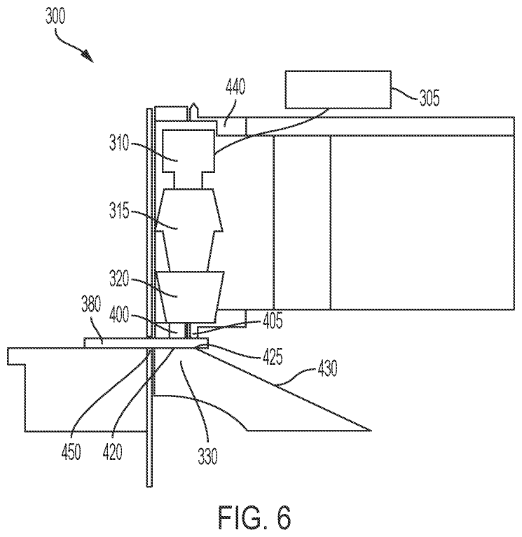

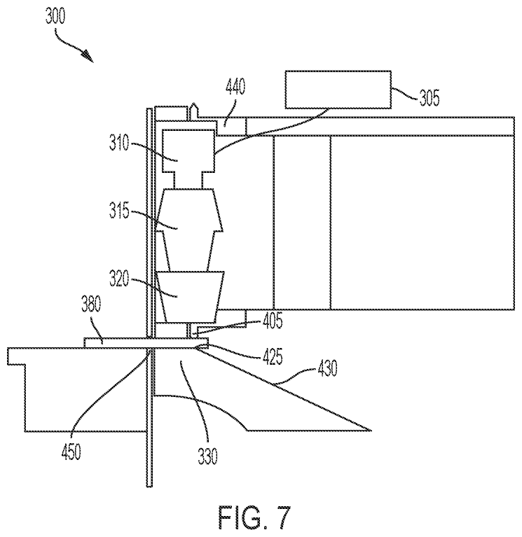

The apparatus 300 can include the welding interface 400 and the trimmer 405 (as depicted in at least FIGS. 3-4 and 6). The anvil 330 can receive the foil 375, and the horn 320 can oscillate the welding interface 400 to weld the foil 375 and the trimmer 405 to trim the foil 375 (as depicted in at least FIGS. 3-4). The anvil 330 can receive the electrode stack 380, and the horn 320 can oscillate the welding interface 400 to weld a component of the electrode stack 380 or the trimmer 405 to trim a component of the electrode stack 380 (as depicted in at least FIG. 6). The apparatus 300 can include the trimmer 405 (as depicted in at least FIGS. 5 and 7). The anvil 330 can receive the foil 375, and the horn 320 can oscillate the trimmer 405 to trim the foil 375 (as depicted in at least FIG. 5). The anvil 330 can receive the electrode stack 380, and the horn 320 can oscillate the trimmer 405 to trim a component of the electrode stack 380 (as depicted in at least FIG. 7).

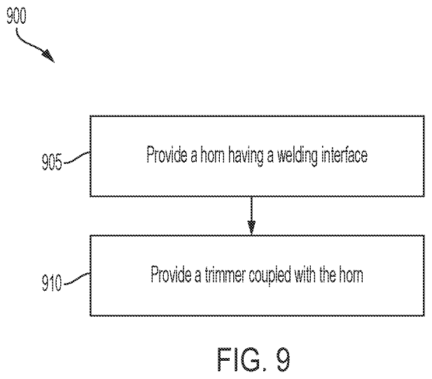

FIG. 9 depicts an illustration of a method 900. The method 900 can include one or more ACTS 905-910. The method 900 can include providing a horn 320 having a welding interface 400, as depicted at ACT 905. The welding interface 400 can oscillate to weld a foil 375. For example, the horn 320 can oscillate the welding interface 400 at a first resonance frequency to weld the foil 375. The welding interface 400 can oscillate at a first resonance frequency of about (e.g., within 10%) 40 kHz, or another frequency or range of frequencies, to weld the foil 375. The welding interface 400 can oscillate during a first acoustic burst to weld the foil 375. For example, the first acoustic burst can at least partially overlap in time with another acoustic burst (e.g., a second acoustic burst), or the first acoustic burst can proceed sequentially in time with another acoustic burst (e.g., a second acoustic burst). The horn 320 can oscillate the welding interface 400 along a first axis to weld the foil 375. For example, the horn 320 can oscillate the welding interface 400 along a first axis that is aligned with a welding surface 420 of an anvil 330.

The method 900 can include providing a trimmer 405 coupled with the horn 320, as depicted at ACT 910. For example, the trimmer 405 can trim the foil 375. The horn 320 can oscillate the trimmer 405 at a second resonance frequency to trim the foil 375. For example, the trimmer 405 can oscillate at a second resonance frequency of about (e.g., within 10%) 40 kHz, or another frequency or range of frequencies, to trim the foil 375. The trimmer 405 can oscillate during a second acoustic burst to trim the foil 375. The second acoustic burst can at least partially overlap in time with another acoustic burst (e.g., the first acoustic burst). For example, the horn 320 can oscillate the welding interface 400 to weld the foil 375 (e.g., during the first acoustic burst) and the trimmer 405 to trim the foil 375 (e.g., during the second acoustic burst) simultaneously. The second acoustic burst can proceed sequentially in time relative to another acoustic burst (e.g., the first acoustic burst). For example, the horn 320 can oscillate the welding interface 400 to weld the foil 375 (e.g., during the first acoustic burst) and the trimmer 405 to trim the foil 375 (e.g., during the second acoustic burst) sequentially. The horn 320 can oscillate the trimmer 405 along a second axis to trim the foil 375. For example, the horn 320 can oscillate the trimmer 405 along a second axis that is aligned with a trimming surface 425 of an anvil 330. The second axis (e.g., an axis of oscillation of the trimmer 405) can be aligned with (e.g., parallel to) the first axis (e.g., an axis of oscillation of the welding interface 400). The horn 320 can oscillate the trimmer along a second axis that is misaligned with the trimming surface 425 (e.g., at a 30, 45, 60, 90 degree angle, perpendicular to the trimming surface 425, or at another orientation).

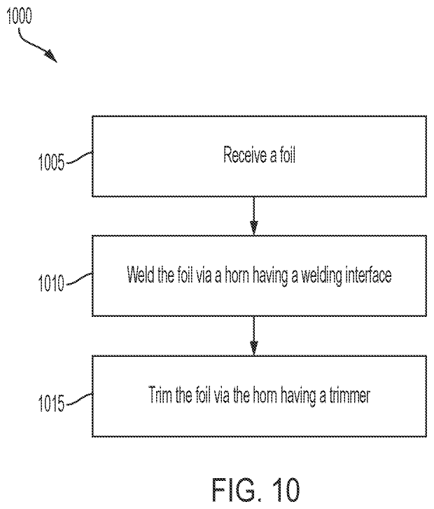

FIG. 10 depicts an illustration of a method 1000. The method 1000 can include one or more ACTS 1005-1015. The method 1000 can include receiving a foil 375, as depicted at ACT 1005. The foil 375 can be a foil that makes up stacked electrode material of a battery cell. For example, the foil 375 can be a material to build an electrode (e.g., an anode layer, a cathode layer, or other electrode material), or another suitable stack of material (e.g., an electrolyte layer) used to build an electrode stack, a battery cell, a battery pack, or other components of a battery. The electrode stack can include one or more layers of material, for example one or more anode layers, electrolyte layers, or cathode layers (e.g., stacked layers). The foil 375 can be a first foil of a plurality of foils, where the plurality of foils comprise at least 90 layers of foil. The foil 375 can be or include a first foil of a plurality of foils, where the plurality of foils is another suitable number of foils (e.g., 50, 75, 100, 120, or another number of foils). The foil 375 can be welded or trimmed to form at least one electrode stack 380, and the at least one electrode stack 380 can be used to build at least one battery cell. For example, the electrode stack 380 can be used to build an elongated cell (e.g., a battery cell). The electrode stack 380 (e.g., elongated cell) can also be assembled within a pack, for example to build a cell to pack battery pack.

The method 1000 can include welding the foil 375 via a horn 320 having a welding interface 400, as depicted at ACT 1010. The horn 320 can oscillate the welding interface 400 to weld the foil 375. For example, the horn 320 can oscillate the welding interface 400 at a first resonance frequency to weld the foil 375. The welding interface 400 can oscillate at a first resonance frequency of about (e.g., within 10%) 40 kHz, or another frequency or range of frequencies, to weld the foil 375. The welding interface 400 can oscillate during a first acoustic burst to weld the foil 375. For example, the first acoustic burst can at least partially overlap in time with another acoustic burst (e.g., a second acoustic burst), or the first acoustic burst can proceed sequentially in time with another acoustic burst (e.g., a second acoustic burst). The horn 320 can oscillate the welding interface 400 along a first axis to weld the foil 375. For example, the horn 320 can oscillate the welding interface 400 along a first axis that is aligned with a welding surface 420 of an anvil 330.

The method 1000 can include trimming the foil 375 via the horn 320 having a trimmer 405, as depicted at ACT 1015. The horn 320 can oscillate the trimmer 405 to trim the foil 375. For example, the horn 320 can oscillate the trimmer 405 at a second resonance frequency to trim the foil 375. The trimmer 405 can oscillate at a second resonance frequency of about (e.g., within 10%) 40 kHz, or another frequency or range of frequencies, to trim the foil 375. The trimmer 405 can oscillate during a second acoustic burst to trim the foil 375. The second acoustic burst can at least partially overlap in time with another acoustic burst (e.g., the first acoustic burst). For example, the horn 320 can oscillate the welding interface 400 to weld the foil 375 (e.g., during the first acoustic burst) and the trimmer 405 to trim the foil 375 (e.g., during the second acoustic burst) simultaneously. The second acoustic burst can proceed sequentially in time relative to another acoustic burst (e.g., the first acoustic burst). For example, the horn 320 can oscillate the welding interface 400 to weld the foil 375 (e.g., during the first acoustic burst) and the trimmer 405 to trim the foil 375 (e.g., during the second acoustic burst) sequentially. The horn 320 can oscillate the trimmer 405 along a second axis to trim the foil 375. For example, the horn 320 can oscillate the trimmer 405 along a second axis that is aligned with a trimming surface 425 of an anvil 330. The second axis (e.g., an axis of oscillation of the trimmer 405) can be aligned with (e.g., parallel to) the first axis (e.g., an axis of oscillation of the welding interface 400). The horn 320 can oscillate the trimmer along a second axis that is misaligned with the trimming surface 425 (e.g., at a 30, 45, 60, 90 degree angle, perpendicular to the trimming surface 425, or at another suitable orientation).

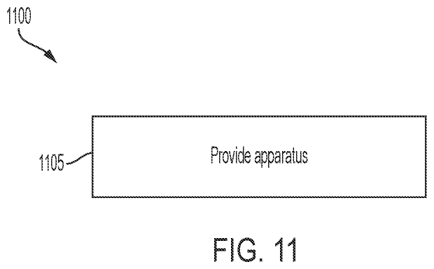

FIG. 11 depicts an illustration of a method 1100. The method 1100 can include providing the apparatus 300, as described at ACT 1105. The apparatus 300 can include a horn 320 having a welding interface 400. The horn 320 can oscillate the welding interface 400 to weld a foil 375. For example, the horn 320 can oscillate the welding interface 400 at a first resonance frequency to weld the foil 375. The apparatus 300 can also include a trimmer 405 coupled with the horn 320. The horn 320 can oscillate the trimmer to trim the foil 375. For example, the horn 320 can oscillate the trimmer 405 at a second resonance frequency to trim the foil 375. The horn 320 can oscillate the welding interface 400 to weld the foil 375 and oscillate the trimmer 405 to trim the foil 375 simultaneously. The horn 320 can also oscillate the welding interface 400 to weld the foil 375 and oscillate the trimmer 405 to trim the foil 375 sequentially.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Other substitutions, modifications, changes, and omissions can also be made in the design, operating conditions, and arrangement of the disclosed elements and operations without departing from the scope of the present disclosure. For example, the apparatus 300 can include several welding interfaces 400 or trimmers 405 that interface with the foil 375. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a horn having a welding interface, the horn configured to oscillate the welding interface at a first resonance frequency to weld a foil; and
a trimmer coupled with the horn, the horn configured to oscillate the trimmer at a second resonance frequency to trim the foil.

2. The apparatus of claim 1, comprising:
the horn configured to oscillate the welding interface to weld the foil and to oscillate the trimmer to trim the foil simultaneously.

3. The apparatus of claim 1, comprising:
the horn configured to oscillate the welding interface during a first acoustic burst to weld the foil; and
the horn configured to oscillate the trimmer during a second acoustic burst to trim the foil;
wherein the first acoustic burst at least partially overlaps in time with the second acoustic burst.

4. The apparatus of claim 1, comprising:
the horn configured to oscillate the welding interface to weld the foil and to oscillate the trimmer to trim the foil sequentially.

5. The apparatus of claim 1, comprising:
the horn configured to oscillate the welding interface during a first acoustic burst to weld the foil; and
the horn configured to oscillate the trimmer during a second acoustic burst to trim the foil;
wherein the first acoustic burst and the second acoustic burst proceed sequentially in time.

6. The apparatus of claim 1, wherein the foil is a first foil of a plurality of foils, comprising:
the horn configured to oscillate the trimmer to trim the plurality of foils, the plurality of foils comprising at least 90 layers of foil.

7. The apparatus of claim 1, comprising:
the horn configured to oscillate the welding interface at the first resonance frequency along a first axis; and
the horn configured to oscillate the trimmer at the second resonance frequency along a second axis that is aligned with the first axis.

8. The apparatus of claim 1, comprising:
the welding interface positioned at a bottom portion of the horn; and
the welding interface to engage a top surface of the foil to weld the foil.

9. The apparatus of claim 1, comprising:
the welding interface positioned at a top portion of the horn; and
the welding interface to engage a bottom surface of the foil to weld the foil.

10. The apparatus of claim 1, comprising:
the trimmer having a cutting blade to oscillate in a horizontal direction at the second resonance frequency to trim the foil.

11. The apparatus of claim 1, comprising:
a balancer coupled with the horn, the balancer having a mass and configured to oscillate at a third frequency.

12. The apparatus of claim 1, comprising:
a guide coupled with an anvil, the guide positioned to orient the foil a first distance from the guide and a center of the welding interface and to orient the foil a second distance from the guide and the trimmer, where the first distance is less than the second distance.

13. The apparatus of claim 1, comprising:
an anvil having a welding surface, the anvil positioned opposite the welding interface; and
the welding surface to receive the foil to position the foil between the anvil and the welding interface to weld the foil.

14. The apparatus of claim 1, comprising:
an anvil having a sloped surface, the anvil positioned opposite the trimmer; and
the sloped surface to receive a portion of the foil separated from the foil when the trimmer trims the foil.

15. A method, comprising:
providing a horn having a welding interface, the horn configured to oscillate the welding interface at a first frequency to weld a foil; and
providing a trimmer coupled with the horn, the horn configured to oscillate the trimmer at a second frequency to trim the foil.

16. The method of claim 15, comprising:
providing the horn configured to oscillate the welding interface to weld the foil and to oscillate the trimmer to trim the foil simultaneously.

17. A method, comprising:
receiving a foil;
welding the foil, via a horn having a welding interface, the welding including oscillating the welding interface at a first frequency to weld the foil;
trimming the foil, via a trimmer coupled with the horn, the trimming including oscillating the trimmer at a second frequency to trim the foil.

18. The method of claim 17, comprising:
welding the foil, via the horn having the welding interface, and trimming the foil, via the trimmer coupled with the horn, simultaneously.

19. The method of claim 17, comprising:
welding the foil, via the horn having the welding interface, during a first acoustic burst;
trimming the foil, via the trimmer coupled with the horn, during a second acoustic burst;
wherein the first acoustic burst at least partially overlaps in time with the second acoustic burst.

20. The method of claim 17, comprising:
trimming the foil, wherein the foil is a first foil of a plurality of foils; and
trimming the plurality of foils, the plurality of foils comprising at least 90 layers of foil.
